(19) United States
(12) Patent Application Publication
(10) Pub. No.: US 2005/0171232 A1
(43) Pub. Date: Aug. 4, 2005

(54) Methods of inhibiting the adherence of lenses to their packaging materials

(76) Inventors: James D. Ford, Orange Park, FL (US); Frank Molock, Orange Park, FL (US); Azaam Alli, Jacksonville, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/982,231

(22) Filed: Nov. 5, 2004

Related U.S. Application Data
(60) Provisional application No. 60/517,434, filed on Nov. 5, 2003.

(51) Int. Cl. C08L 1/00

(52) U.S. Cl. 523/106

(57) ABSTRACT

Methods of reducing the adherence of lenses to hydrophobic packing materials using particular surfactants are disclosed.

### RELATED APPLICATIONS

This application claims priority from a provisional patent application, U.S. Pat. App. No. 60/517,434 of the same title, filed on Nov. 5, 2003.

This invention related to packaging solutions for use with contact lenses and methods for their use.

### BACKGROUND

Contact lenses have been used commercially to improve vision since the 1950s. The first contact lenses were made of hard materials. Although these lenses are currently used, they are not suitable for all patients due to their poor initial comfort. Later developments in the field gave rise to soft contact lenses, based upon hydrogels, which are extremely popular today. These lenses have higher oxygen permeabilities and such are often more comfortable to wear than contact lenses made of hard materials. However, these new lenses are not without problems.

Contact lenses with high oxygen permeabilites are typically made of hydrophobic materials. The packaging for contact lenses are also made of hydrophobic materials. When one hydrophobic surface comes in contact with another, the surfaces stick to each other. The sticking of a contact lens to its packaging creates many problems. First the packaging is thicker and more rigid than the soft lenses contained therein. If a lens sticks to the packaging, when the user tries to remove the lens, the lens often tears and must be discarded. One solution to this problem is to place a hydrophilic additive such as a surfactant, into the lens packaging solution. However many surfactants that have been used to solve this problem do not prevent the sticking of contact lenses to their packaging. In addition, some surfactants do not completely dissolve in lens packaging solutions and have unfavorable interactions with the lens when they are stored over a period of time. Still further, some of the surfactants distort the physical properties of the lens, such as the diameter, the base curve, or the water content of the lens. Therefore there is a need for methods of inhibiting the adherence of contact lenses to their packaging. It is this need that is met by the following invention.

### DETAILED DESCRIPTION OF THE INVENTION

This invention includes a method of inhibiting the adherence of a soft lens to hydrophobic packaging materials comprising, consisting essentially of, or consisting of storing the soft lens in a packaging solution comprising an effective amount of an appropriate surfactant.

As used herein, the “packaging solutions” of the invention may be water-based solutions. Typical solutions include, without limitation, saline solutions, other buffered solutions, and deionized water. The preferred aqueous solution is deioinized water or saline solution containing salts including, without limitation, sodium chloride, sodium borate, sodium phosphate, sodium hydrogenphosphate, sodium dihydrogenphosphate, or the corresponding potassium salts of the same. These ingredients are generally combined to form buffered solutions that include an acid and its conjugate base, so that addition of acids and bases cause only a relatively small change in pH. The buffered solutions may additionally include 2-(N-morpholino)ethanesulfonic acid (MES), sodium hydroxide, 2,2-bis(hydroxymethyl)-2,2′,2″-nitrilotriethanol, n-tris(hydroxymethyl)methyl-2-aminoethanesulfonic acid, citric acid, sodium citrate, sodium carbonate, sodium bicarbonate, acetic acid, sodium acetate, ethylenediamine tetraacetic acid and the like and combinations thereof. Preferably, the solution is a borate buffered or phosphate buffered saline solution or deionized water.

As used herein the term “storing” refers to contacting the soft lens with the packaging solution. Storing includes but is not limited to processing the lenses during manufacture or sterilizing soft lenses at a particular temperature and pressure, and subsequently maintaining those lenses at about room temperature prior to use by a consumer. The packaging solutions of the invention may be used to sterilize soft lenses in their packaging. Sterilization conditions include heating a sealed package for a period of time at a temperature and a pressure known to kill microorganisms. An example of such conditions is heating a sealed package for about 30 minutes at about 121° C. and at 10-16 psi. When sterilizing the soft lenses with their packaging solutions, any adverse interactions between the appropriate surfactant and the lens are critical because the normal four year shelf life of the sealed lenses. Examples of the use of these packaging solutions in the manufacturing of soft lenses, include but are not limited to hydrating, inspecting or transferring those lenses throughout a manufacturing line. Sterilization and subsequent storage of packaged soft lenses is the preferred method of practicing this invention.

As used herein, an “appropriate surfactant” is a surfactant that inhibits the adherence to the hydrophobic packaging material but does not degrade the hydrophobic packaging material, or change the physical parameters of the lens such as lens diameter, base curve or water content. It is preferred that water content of soft lenses packaged with the appropriate surfactant neither increase or decrease greater than 1%, more preferably greater than 0.8%. The preferred appropriate surfactant is methyl cellulose. Methyl cellulose is a polymer and the preferred molecular weight of that polymer is greater than 750,000 daltons, more preferably about 1,000,000 daltons. The preferred supplier for methyl cellulose is Fisher Scientific's brand M352 that is methoxylated 27.5% to 31.5% and a 2% solution thereof has a viscosity of 3,000 to 5,600 centipoise. Attempts to used other surfactants, including but not limited to Dextran 70, hydroxy ethylcellulose, hydroxypropyl methycellulose, hydroxymethyl cellulose, hydroxyethyl methylcellulose, and Glucamate DOE 120 were made. However none of those surfactants were suitable due to either their interaction with either the lens (for example distorting the dimensions of the lens or interacting with the lens material) or the hydrophobic packaging.

The term “effective amount” refers to the amount of appropriate surfactant (measured as weight percentage of the total weight of the packaging solution) necessary to prevent sticking of lenses to their packaging. The effective amount is about 0.001% to about 0.1%, more preferably about 0.001% to about 0.05%. The most preferred effective amount is about 0.005% (50 ppm) to about 0.01% (100 ppm).

The appropriate surfactant of the invention may be combined with any known active or carrier components useful for lens packaging solutions. Suitable additional ingredients include but are not limited to antibacterial agents, anti-dryness agents, such a polyvinyl alcohol, polyvinyl pyrrolidone, and dextran, tonicity agents, and combinations thereof.

As used herein “soft lens” refers to an ophthalmic device that resides in or on the eye. These devices can provide optical correction or may be cosmetic. The term lens includes but is not limited to soft contact lenses, intraocular lenses, overlay lenses, ocular inserts, and optical inserts. The preferred lenses of the invention are soft contact lenses are made from silicone elastomers or hydrogels, which include but are not limited to silicone hydrogels, and fluorohydrogels. Soft contact lens formulations are disclosed in U.S. Pat. No. 5,710,302, WO 9421698, EP 406161, JP 2000016905, U.S. Pat. No. 5,998,498, U.S. patent application Ser. No. 09/532,943, U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631. The foregoing references are hereby incorporated by reference in their entirety. The particularly preferred lenses of the inventions made from etafilcon A, genfilcon A, galifilcon A, senofilcon A, lenefilcon A, lotrfilcon A, lotrifilcon B, balifilcon A, or polymacon. More particularly preferred lenses of the invention made from genfilcon A, galifilcon A, senofilcon A, lenefilcon A, lotrfilcon A, lotrifilcon B, or balifilcon A. The most preferred lenses include but are not limited to galifilcon A, senofilcon A, and lenses disclosed in U.S. Pat. App. No. 60/318,536, entitled Biomedical Devices Containing Internal wetting Agents,” filed on Sep. 10, 2001 and its non-provisional counterpart of the same title, U.S. Ser. No. 10/236,538, filed on Sep. 6, 2002, U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631. These patents as well as all other patents disclosed in this application are hereby incorporated by reference in their entirety.

“Hydrophobic packaging materials,” refer to substances that are used to prepare containers for manufacturing lenses prior to their use by an end user. These packaging materials are discarded by the user after the soft contact lens is placed in the eye of a user. Examples of hydrophobic packaging materials include but are not limited to polypropylene, polyethylene, nylons, olefin co-polymers, acrylics, rubbers, urethanes, polycarbonates, or fluorocarbons. The preferred materials are metallocenes polymers and co-polymers made of polypropylene, polyethylene, having a melt flow range of about 15 g/10 minutes to about 44 g/10 minutes as determined by ASTM D-1238. Containers made from hydrophobic packaging material may be in many forms. These containers may store a single lenses or many lenses. An example of a single lens storage unit is a blister package, such as the packages disclosed in the following publications, U.S. Pat. Nos. D435,966 S; 4,691,820; 5,467,868; 5,704,468; 5,823,327; 6,050,398, which are hereby incorporated by reference in their entirety. Examples of multiple lens storage units include the hydrophobic molds that are used to produce contact lenses as shown in U.S. Pat. No. 4,640,489 which is hereby incorporated in reference in its entirety. Other examples include trays, or other containers used in the process of producing soft lenses.

### EXAMPLES

The following abbreviations are used in the examples below:
DMA N,N-dimethylacrylamide
DPM dipropylene glycol monomethyl ether
HEMA 2-hydroxyethyl methacrylate
mPDMS 800-1000 MW monomethacryloxypropyl terminated polydimethylsiloxane
Norbloc 2-(2′-hydroxy-5-methacrylyloxyethylphenyl)-2H-benzotriazole
CGI 1850 1:1 (wgt) blend of 1-hydroxycyclohexyl phenyl ketone and bis(2,6-dimethoxybenzoyl)-2,4-4-trimethylpentyl phosphine oxide
PVP 2,500-360,000 poly(N-vinyl pyrrolidone) having a molecular weight of approximately 2,500 to 360,000
Blue HEMA the reaction product of Reactive Blue 4 and HEMA, as described in Example 4 of U.S. Pat. No. 5,944,853
IPA isopropyl alcohol
D3O 3,7-dimethyl-3-octanol
standard packaging solution adding 0.10 weight % of sodium borate, 0.91 weight % Boric Acid, 0.83% Sodium Chloride, 0.01% EDTA and 98.15 weight % water into a volumetric flask and was mixed at ambient temperature until all solids were dissolved. Solution A has a pH of 7.6 (measured at 20-30° C.), an osmolality of 170 (measured at ca. 25° C.) and a conductivity (m/S/cm) of 0.7 (measured at 20-30° C.)
TEGDMA tetraethyleneglycol dimethacrylate
TRIS 3-methacryloxypropyltris(trimethylsiloxy)silane
DOE-120 CTFA name: Polyethylene glycol 120 methyl glucose dioleate
EDTA ethylenediamine tetraacetic acid
DI Deionized water
Macromer 2 the reaction product of described in the examples of U.S. patent application Ser. No. 10/028,400 filed on Dec. 20, 2001 and entitled Antimicrobial Contact Lenses and Methods for Their Production
DPMA dipropylene glycol methyl ether acetate
N/A not tested
Big Blue A mixture of 900 mg blue HEMA, 44.1 g HEMA, 615 mg CGI 1850 and 150 mL ethylene glycol was stirred until homogeneous and the system was degassed as described in example 1. The mixture was transferred to a large crystallizing dish and covered with a watch glass. Polymerization of the olefinic moieties was conducted under visible light for approximately 1 hour (Phillips TL20 W/03T bulbs). Upon quenching of the polymerization using oxygen, the mixture was poured into 500 mL of borate-buffered saline solution and stirred for several hours until the material was transformed into a more rigid form. The liquids were decanted, and the product was washed with another 500 mL of borate-buffered saline solution, the polymer was cut into several smaller pieces, and stirred in 500 mL of deionized water for more than 1 hour to the point that the product became gel-like and sparingly soluble in the solvent. The mixture was then diluted with a small quantity of borate-buffered saline solution to enable better precipitation of the polymer. The mixture was filtered and washed in deionized water until the material did not appear soluble. The suspension was filtered, dried in a rotary evaporator, cut into smaller pieces and further dried until it appeared crystalline and anhydrous. The dark blue polymer was then milled into fine particles and subjected to more deionized water washings accompanied by 1 to 2 hours of stirring with each wash. Washing continued until little or no blue color was visible in solution and the product was filtered, dried at reduced pressure, and ground in a blender.
   GPC data for each of the polymers were obtained using both R.I and light scattering detectors. Chromatography was performed using a mixed bed GPC column (phenogel 300 mm×7.8 mm×5 micron (2) column (Phenomenex) having a separation range of 100 K to 10,000 K, and 0.5 wt % lithium bromide in dimethylformamide as the eluent.
   Mn=1.133×10⁶; Mw=1.222×10⁶; Mz=1.354×10⁶; polydispersity (Mw/Mn)=1.078.

### Lens Preparation

Lenses G, H, J, and K

Monomer mix is prepared by blending 17.98 weight percent of GTP (Macromer 2), 28% mPDMS, 14% TRIS, 26% DMA, 5% HEMA, 5% PVP (360,000 molecular weight), 2% Norbloc, 1% TEGDMA, 0.02% Blue HEMA, 1% CGI 1850, in a blend with 80 parts of this combination with 20 parts D30 diluent. Thermoplastic contact lens molds were coated with pHEMA (great white) coating on the surface as per the method disclosed in U.S. patent application Ser. No. 09/921,192 entitled “Method for Correcting Articles by Mold Transfer.” Subsequently, the contact lenses were made by placing this monomer mix into thermoplastic contact lens molds, and irradiating using Philips TL20W/03T fluorescent bulbs at 70° C. for about 15 minutes. The molds were opened and lenses were extracted into DPM. Subsequently, the lenses were equilibrated in either DI, or a combination of 0.01 weight per of methyl cellulose in DI and 0.005 weight percent of methyl cellulose in standard packaging solution. Lenses G and H were equilibrated in DI. Lenses J and K were equilibrated in a combination of 0.01 weight per of methyl cellulose in DI and 0.005 weight percent of methyl cellulose in standard packaging solution.

### Standard Packaging Solution With and Without an a Surfactant

### Example 1

Lenses H, J, and K were packaged in blister packs using only packaging solution or 0.005 weight percent of methyl cellulose as listed in Table 1. Lenses G were packaged in glass vials without any surfactant. The packaged lenses were autoclaved (121° C., 30 minutes) and visually evaluated to determine whether the lenses stuck to the packaging. The data is presented in Table 1 and indicates that methyl cellulose prevents the sticking of lenses to their packaging.

TABLE 1

| | | percentage of |
|---|---|---|
| | weight percent | lenses that are |
| Lens | of methyl | stuck to the |
| Type | cellulose | packaging |
| G | None | 0% |
| H | 0.005 | 0% |
| J | None | 98% |
| K | 0.005 | 0% |

1. A method of inhibiting the adherence of a soft lens to hydrophobic packaging materials comprising, storing the soft lens in a packaging solution comprising an effective amount of an appropriate surfactant

2. The method of claim 1 wherein the appropriate surfactant is methyl cellulose.

3. The method of claim 1 wherein the effective amount the appropriate surfactant is about 0.001% to about 0.05%.

4. The method of claim 1 wherein the appropriate surfactant is methyl cellulose and the effective amount is about 0.001% to about 0.01%.

5. The method of claim 1 wherein the appropriate surfactant is methyl cellulose and the effective amount is about 0.005%.

6. The method of claim 1 wherein the packaging solution comprises deionized water.

7. The method of claim 5 wherein the packaging solution comprises deionized water.

8. The method of claim 5 wherein the packaging solution comprises borate buffered or phosphate buffered saline solution.

9. The method of claim 1 wherein an appropriate surfactant does not distort the physical properties of the soft lens.

10. The method of claim 9 wherein the appropriate surfactant does not distort the diameter, base curve or water content of the soft lens.

11. The method of claim 9 wherein the appropriate surfactant does not distort the diameter or base curve of the soft lens.

12. The method of claim 9 wherein the appropriate surfactant does not distort the water content of the soft lens.

13. The method of claim 9 wherein the appropriate surfactant does not increase or decrease the water content of the lens more than about 1%.

14. The method of claim 9 wherein the appropriate surfactant does not increase or decrease the water content of the lens more than about 0.8%.

15. The method of claim 13 wherein the appropriate surfactant is methyl cellulose.

16. The method of claim 9 wherein the appropriate surfactant does not distort the diameter of the soft lens.

17. The method of claim 9 wherein the appropriate surfactant is methyl cellulose.

18. The method of claim 1 wherein the soft lenses comprise genfilcon A, galifilcon A, senofilcon A, lenefilcon A, lotrfilcon A, lotrifilcon B, or balifilcon A.

19. The method of claim 1 wherein the soft lenses comprise galifilcon A or senofilcon A.

20. The method of claim 9 wherein the soft lenses comprises galifilcon A or senofilcon A.

21. The method of claim 9 wherein the soft lens comprises genfilcon A, galifilcon A, senofilcon A, lenefilcon A, lotrfilcon A, lotrifilcon B, or balifilcon A.

22. The method of claim 13 wherein the soft lens comprises genfilcon A, galifilcon A, senofilcon A, lenefilcon A, lotrfilcon A, lotrifilcon B, or balifilcon A.
